(19) United States
(12) Patent Application Publication
(10) Pub. No.: US 2026/0160600 A1
(43) Pub. Date: Jun. 11, 2026

(54) INFRARED DETECTION ELEMENT AND INFRARED SENSOR HAVING SAME

(71) Applicant: TDK Corporation, Tokyo (JP)

(72) Inventors: Shinji HARA, Tokyo (JP); Eiji KOMURA, Tokyo (JP); Naoki OHTA, Tokyo (JP); Susumu AOKI, Tokyo (JP); Takahiro NAKAGAWA, Tokyo (JP)

(73) Assignee: TDK Corporation, Tokyo (JP)

(21) Appl. No.: 19/376,175

(22) Filed: Oct. 31, 2025

(30) Foreign Application Priority Data
Dec. 9, 2024 (JP) 2024-214221

(51) Int. Cl. G01J 5/22; G01J 5/02; G01J 5/08; G01J 5/20

(52) U.S. Cl. CPC G01J 5/22; G01J 5/022; G01J 5/0853; G01J 2005/202

(57) ABSTRACT

An infrared detection element comprises a temperature sensing layer and an infrared absorption layer that is provided in addition to the temperature sensing layer for absorbing infrared rays and converting the infrared rays into heat. The temperature sensing layer is thermally connected to the infrared absorption layer. The infrared absorption layer includes an iron oxide.

### FIELD

This application claims the benefit of Japanese Priority Patent Application No. 2024-214221 filed on Dec. 9, 2024, the entire contents of which are incorporated herein by reference.

This disclosure relates to an infrared detection element and an infrared sensor having same.

### BACKGROUND

Infrared sensors that detect infrared rays are known. A temperature sensing layer of an infrared sensor undergoes a temperature change due to infrared rays incident from the outside, and the temperature change in the temperature sensing layer is represented as a resistance change. Therefore, to improve the performance of infrared sensors, increasing the absorption efficiency of the infrared rays that are absorbed by the temperature sensing layer and the surroundings of the temperature sensing layer is important. International Publication No. WO2019/171488 describes an infrared sensor comprising a radiation shield facing the opposite side of the infrared-incident surface of a bolometer film. The distance between the bolometer film and the radiation shield is about ¼ the wavelength of the incident infrared rays. This distance allows interference between the infrared rays incident on the radiation shield and the infrared rays reflected by the radiation shield and allows the infrared rays to be efficiently captured by the bolometer film. JP2024-129503A describes an electromagnetic wave sensor comprising a thermistor film that is covered with a dielectric layer. The dielectric layer functions as an electromagnetic wave absorber.

The radiation shield described in International Publication No. WO2019/171488 can increase the infrared absorption efficiency in a specific narrow wavelength range, but increasing the infrared absorption efficiency over a wide wavelength range is problematic. The dielectric layer described in JP2024-129503A absorbs infrared rays over a wide wavelength range but has low infrared absorption efficiency.

### SUMMARY

The infrared detection element of this disclosure comprises a temperature sensing layer and an infrared absorption layer provided in addition to the temperature sensing layer for absorbing infrared rays and converting the rays into heat, wherein the temperature sensing layer is thermally connected to the infrared absorption layer, and the infrared absorption layer includes iron oxides.

The above and other objects, features, and advantages of the present application will become apparent from the following detailed description with reference to the accompanying drawings which illustrate the present application.

### BRIEF DESCRIPTION OF DRAWINGS

FIG. 1 is a schematic side view of an infrared sensor according to a first example embodiment of the present disclosure;

FIG. 2 is a partial schematic plan view of FIG. 1;

FIG. 3 is an enlarged view of section A in FIG. 1;

FIG. 4 is a cross-sectional view along line B-B of FIG. 3;

FIG. 5 shows the absorption coefficients of several substances;

FIG. 6 is a schematic side view of an infrared detection element according to a second example embodiment of the present disclosure;

FIG. 7 is a schematic side view of an infrared detection element according to a third example embodiment of the present disclosure;

FIG. 8 is a schematic side view of an infrared detection element according to a fourth example embodiment of the present disclosure;

FIG. 9 is a schematic side view of an infrared detection element according to a fifth example embodiment of the present disclosure;

FIG. 10 is a schematic side view of an infrared sensor according to a sixth example embodiment of the present disclosure; and

FIG. 11 is an enlarged view of section C in FIG. 10.

### DETAILED DESCRIPTION

It is desired to provide an infrared detection element that can increase the infrared absorption efficiency over a wide range of wavelengths.

Example embodiments of an infrared detection element and an infrared sensor with an infrared detection element of the present disclosure are described below with reference to the drawings. The drawings are schematic views to illustrate the present disclosure, and the shapes and dimensions of the elements may not match between the drawings. In the following description and drawings, the X-and Y-directions are parallel to principal surface 1A of first substrate 1 and principal surface 2A of second substrate 2. Principal surfaces 1A and 2A are the surfaces of first substrate 1 and second substrate 2 that face each other. The X- and Y-directions are orthogonal to each other; the Z-direction is orthogonal to the X- and Y-directions and is perpendicular to principal surface 1A of first substrate 1 and principal surface 2A of second substrate 2, or alternatively, is the direction of film thickness of temperature sensing layer 22.

Infrared sensors may be used as image sensors for infrared cameras. Infrared cameras can be used as night vision scopes and night vision goggles in dark places and can also be used to measure the temperature of people and objects.

### FIRST EXAMPLE EMBODIMENT

### Overall Structure

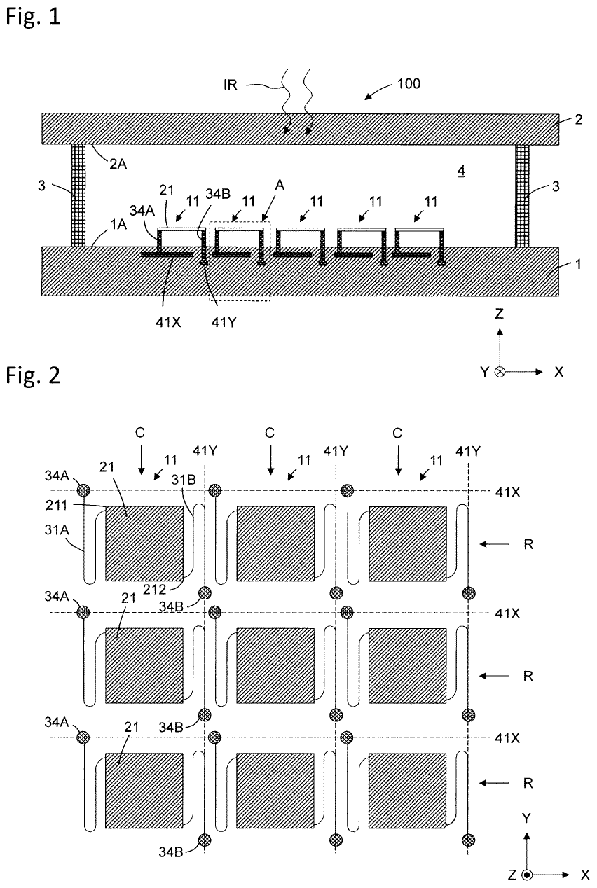

FIG. 1 is a schematic side view of infrared sensor 100. In FIG. 1, suspensions 31A and 31B are omitted. Five infrared detection elements 11 are arranged in the X-direction, but as described below, the number of infrared detection elements 11 is not limited. Infrared sensor 100 has first substrate 1 and second substrate 2 arranged opposite each other, and side walls 3 connect and circumferentially surrounding first substrate 1 and second substrate 2. First substrate 1, second substrate 2, and side walls 3 form sealed interior space 4. In interior space 4, infrared sensing elements 11 are provided that function as the sensing part of infrared sensor 100. Since interior space 4 is under negative pressure or in a vacuum, convection of gas in interior space 4 is prevented or suppressed, whereby the thermal effect upon infrared detection elements 11 is reduced.

First substrate 1 is made of a silicon substrate and supports infrared detection elements 11. First substrate 1 has electrical circuits such as readout IC (ROIC) that read the output signals of infrared detection elements 11 as well as internal wiring (none of which is shown). Pads (not shown) are formed on the outside surfaces of side walls 3 of first substrate 1 for input from and output to the outside. The pads are electrically connected to electrical circuits by internal wiring. Second substrate 2 is also formed mainly by a silicon substrate and constitutes the input portion of the infrared rays IR. Second substrate 2 is the substrate on the side from which enter the infrared rays IR to be detected. Second substrate 2 transmits infrared rays IR and thus allows the infrared rays IR to enter infrared detection element 11. First substrate 1 and second substrate 2 may be germanium substrates that transmit infrared rays IR.

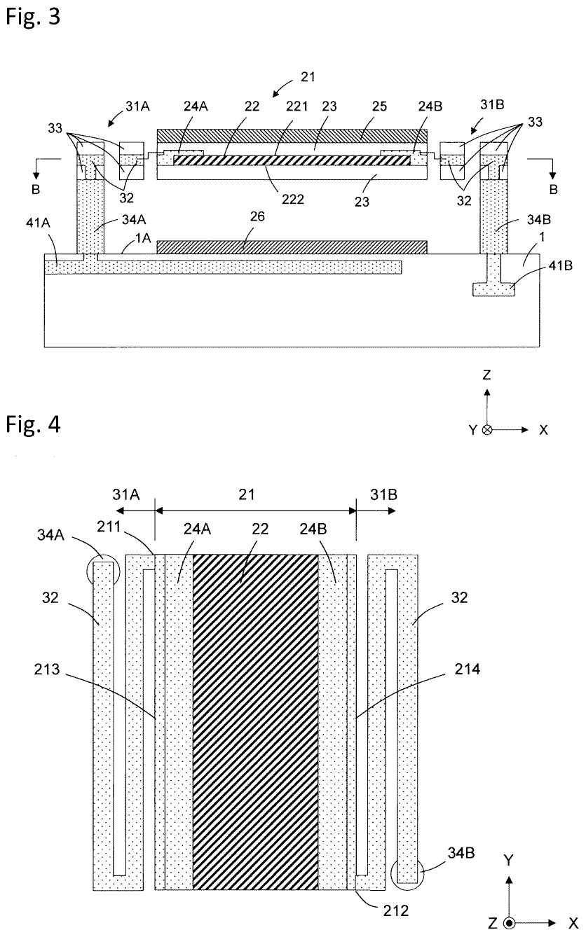

FIG. 2 is a partial plan view of FIG. 1 viewed in the Z-direction and also schematically shows first wiring 41X and second wiring 41Y. FIG. 3 is an enlarged view of section A in FIG. 1, and FIG. 4 is a cross-sectional view along line B-B in FIG. 3. The infrared detection elements 11 are arranged in an array, for example, a two-dimensional grid-like array comprising rows R extending in the X-direction and columns C extending in the Y-direction. Temperature sensing layer 22 (described below) of each infrared sensing element 11 constitutes one cell or pixel in the array. The number of matrices in the array may for example include, but is not limited to, 640 rows and 480 columns, or 1024 rows and 768 columns. First substrate 1 has first wirings 41X extending in the X-direction and wirings 41Y extending in the Y-direction. The first wirings 41X and the second wirings 41Y are provided inside first substrate 1, are electrically connected to the ROIC, and extend in the Z-direction at different positions from each other.

### Structure of Infrared Detection Element 11

As shown in FIGS. 2-4, individual infrared detection elements 11 each have principal body 21 and first and second suspensions 31A and 31B that support principal body 21. Principal body 21 has a generally rectangular shape as viewed from the Z-direction. First suspension 31A is connected near one corner 211 of principal body 21. Second suspension 31B is connected to the vicinity of corner 212 of principal body 21 that is located opposite to corner 211. The locations of the connections between principal body 21 and each of first and second suspensions 31A and 31B are not limited and may be, for example, near the midpoints of two opposing sides 213 and 214 of principal body 21. As shown in FIG. 3, each of first and second suspensions 31A and 31B has conductive layer 32 and two dielectric layers 33 that sandwich conductive layer 32 in the Z-direction. Conductive layer 32 may be formed, for example, of a metal such as titanium or a conductive nitride such as titanium nitride. The two dielectric layers 33 may be formed, for example, of the same material as dielectric layer 23 (described below) of principal body 21. Conductive layer 32 is electrically connected to first and second conductive struts 34A and 34B to be described next.

Individual infrared detection elements 11 each have cylindrical first and second conductive struts 34A and 34B. First conductive strut 34A is electrically connected to corresponding first wiring 41X. Second conductive strut 34B is electrically connected to corresponding second wiring 41Y. First conductive strut 34A supports first suspension 31A and thus supports principal body 21 via first suspension 31A. Second conductive strut 34B supports second suspension 31B and thus supports principal body 21 via second suspension 31B. First conductive strut 34A is electrically connected to conductive layer 32 of first suspension 31A and second conductive strut 34B is electrically connected to conductive layer 32 of second suspension 31B.

Principal body 21 has temperature sensing layer 22, dielectric layer 23, first and second electrode layers 24A and 24B, and infrared absorption layer 25. Temperature sensing layer 22 is, for example, a square or rectangular thermistor film when viewed from the Z-direction, and has incident surface 221 that faces second substrate 2 and into which enter the infrared rays to be detected, and back surface 222 that faces first substrate 1. The shape of temperature sensing layer 22 is not limited to a square or rectangular shape and may assume any shape. Temperature sensing layer 22 contains, for example, at least one of vanadium oxide, amorphous silicon, polycrystalline silicon, an oxide with a spinel-type crystal structure that includes manganese, titanium oxide, and yttrium-barium-copper oxide. Instead of a thermistor film, temperature sensing layer 22 may be a diode film such as a silicon diode film, a thermocouple film, a thermopile film, or a pyroelectric film such as a lead zirconate titanate film.

Dielectric layer 23 covers at least a portion of temperature sensing layer 22. Dielectric layer 23 is provided at least between temperature sensing layer 22 and infrared absorption layer 25, can cover incident surface 221 of temperature sensing layer 22, and can also cover back surface 222 of temperature sensing layer 22. Dielectric layer 23 is formed of aluminum nitride, silicon nitride, aluminum oxide, or silicon oxide and functions as an infrared absorber. In this example embodiment, dielectric layer 23 is provided between temperature sensing layer 22 and infrared absorption layer 25, and temperature sensing layer 22 and infrared absorption layer 25 are not in contact with each other. In this example embodiment, dielectric layers 23 is provided between first electrode layer 24A and infrared absorption layer 25, and between second electrode layer 24B and infrared absorption layer 25, and as a result, first and second electrode layers 24A and 24B are not in contact with infrared absorption layer 25.

As shown in FIG. 4, first electrode layer 24A is provided along one side 213 of principal body 21 and is electrically connected to temperature sensing layer 22. Second electrode layer 24B is provided along side 214 opposite to side 213 of principal body 21 and is electrically connected to temperature sensing layer 22. First and second electrode layers 24A and 24B are in contact with incident surface 221 of temperature sensing layer 22 but also in contact with back surface 222. First electrode layer 24A is electrically connected to conductive layer 32 of first suspension 31A, and second electrode layer 24B is electrically connected to conductive layer 32 of second suspension 31B. First and second electrode layers 24A and 24B supply current to temperature sensing layer 22 in the in-plane direction (X-Y plane) of temperature sensing layer 22. First and second electrode layers 24A and 24B may be formed, for example, of a metal such as titanium or a conductive nitride such as titanium nitride. In this example embodiment, dielectric layer 23 is provided between temperature sensing layer 22 and infrared absorption layer 25, and because temperature sensing layer 22 and infrared absorption layer 25 are not in contact, the current can flow through temperature sensing layer 22 without leaking into infrared absorption layer 25 absorption.

Infrared sensor 100 has infrared reflective layer 26 provided corresponding to individual infrared detection elements 11. Infrared reflective layer 26 is provided at least at a position that confronts principal body 21. A portion of the infrared rays incident from second substrate 2 passes through principal body 21, is reflected by infrared reflection layer 26, and then enters principal body 21. This configuration increases the absorption efficiency of infrared rays into principal body 21. Infrared reflective layer 26 may be formed of a material with high reflectivity for infrared rays, such as gold, copper, or aluminum.

### Structure of Infrared Absorption Layer 25

Each individual infrared detection element 11 has infrared absorption layer 25. Infrared absorption layer 25 is a film-like material that absorbs infrared rays and converts the rays into heat. Infrared absorption layer 25 is provided in addition to temperature sensing layer 22. The heat generated in infrared absorption layer 25 propagates through dielectric layer 23 to temperature sensing layer 22. In other words, temperature sensing layer 22 and infrared absorption layer 25 are thermally connected, and in this example embodiment, temperature sensing layer 22 and infrared absorption layer 25 are thermally connected through dielectric layer 23.

Infrared absorption layer 25 comprises an iron oxide (FeOₓ). For example, the iron oxide comprises at least one of iron oxide (II, III) and iron oxide (III). Iron oxide (II, III) (Fe₃O₄) is iron oxide that includes trivalent iron ions in section A, that has divalent iron ions and trivalent iron ions in section B, and that has an inverse spinel structure. Iron oxide (III) (Fe₂O₃) is iron oxide that includes only trivalent iron ions as iron ions. Infrared absorption layer 25 may include iron oxide (II, III) but not iron oxide (III), iron oxide (III) but not iron oxide (II, III), or may include both iron oxide (II, III) and iron oxide (III).

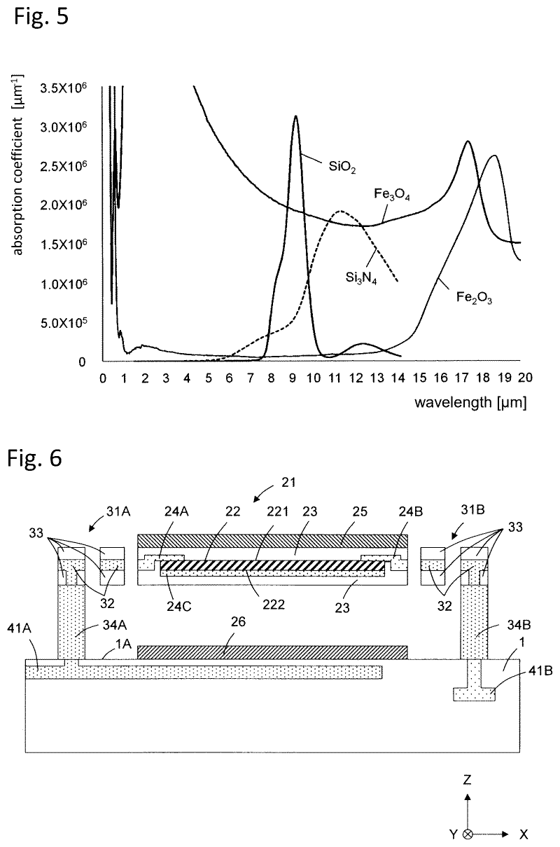

FIG. 5 shows the infrared absorption coefficients of iron oxide (II, III) (Fe₃O₄) and iron oxide (III) (Fe₂O₃) and the infrared absorption coefficients of silicon oxide (SiO₂) and silicon nitride (Si₃N₄) commonly used in dielectric layer 23 that also functions as an infrared absorber. In FIG. 5, the infrared absorption coefficient in the wavelength range of 1 μm to 4 μm for iron oxide (II, III) is higher than the upper limit of the vertical axis of the graph (3.5×10⁶ [μm⁻¹]). Iron oxide (II, III) has high infrared absorption coefficients in the wavelength region of at least 1 μm to 20 μm. Silicon oxide has a high infrared absorption coefficient in the wavelength region of about 8 to 10 μm but has a very low infrared absorption coefficient in other wavelength regions and its infrared absorption coefficient therefore has a very high wavelength dependence. The infrared absorption coefficient of silicon nitride has a lower wavelength dependence than that of silicon oxide, but the wavelength range in which the infrared absorption coefficient is high is limited.

Iron oxide (III) exhibits a high infrared absorption coefficient in the wavelength region above 14 μm and is therefore useful, for example, in infrared sensors 100 for measuring objects at low temperatures. In general, the wavelength of electromagnetic waves emitted by blackbody radiation becomes longer as the temperature of the blackbody decreases. Therefore, when measuring objects at temperatures lower than room temperature, for example, in the measurement of extremely low-temperature objects in space, detecting infrared radiation in the wavelength region of 14 μm or longer is sometimes desired. Infrared absorption layer 25 that includes iron oxide (II, III) can efficiently absorb infrared rays over a wide wavelength region of at least 1 μm to 20 μm and is therefore useful in applications in which detection of infrared rays over a wide wavelength region is desired, as in, for example, sensors used for spectral analysis.

Iron oxide (II, III) and iron oxide (III) are not good conductors, but neither are they insulators; they have conductivity close to that of semiconductors. For example, the resistivity of iron oxide (II, III) is about 1×10⁻⁴Ω·m at 293 K. Therefore, if iron oxide (II, III) and iron oxide (III) can be used as materials for temperature sensing layer 22, infrared absorption layer 25 may be omitted. As mentioned above, the material of temperature sensing layer 22 should exhibit a large change in resistance value with respect to temperature change. The ratio of the change in resistance to temperature change is generally expressed by the resistance-temperature coefficient. The larger the absolute value of the resistance-temperature coefficient, the larger the ratio of change in resistance to temperature change, and thus the greater the sensitivity of infrared sensor 100.

Examples of numerical values of the temperature coefficient of resistance for several materials at 300 K (near room temperature) are illustrated in Table 1. Iron oxide (II, III) and iron oxide (III) can be seen to have resistance-temperature coefficients that are about one order of magnitude smaller than the materials of temperature sensing layer 22 described above, and these materials are therefore not suitable as materials for temperature sensing layer 22. The absolute value of the temperature coefficient of resistance at 300 K of temperature sensing layer 22 may be 2 or more, or may be 3 or more. On the other hand, iron oxide (II, III) and iron oxide (III) have a low temperature detection capacity but high infrared absorption efficiency over a wide wavelength range. Therefore, in this example embodiment, infrared absorption layer 25 is provided in addition to temperature sensing layer 22, and each of the temperature sensing function and the infrared absorbing function is assigned to corresponding one of separate materials (layers) to achieve both a high temperature sensing capacity and high infrared absorption.

TABLE 1

| | |
|---|---|
| Iron oxide (II, III) | −0.2%/K |
| Iron oxide (II) (α phase) | −1.1%/K |
| vanadium oxide (VO) | −2.4%/K |
| amorphous silicon | −2.0%/K |
| titanium oxide | −2.1%/K |
| Oxides having spinel-type crystal | −3.8%/K |
| structure including manganese (one | |
| example) | |

Additional example embodiments are next described with a focus on differences from the first example embodiment. Structure and effects that are the same as in the first example embodiment, and in particular, the structure of infrared absorption layer 25 that is the same as in the first example embodiment, will be omitted from the explanation.

### Second Example Embodiment

FIG. 6 shows a partial schematic side view of infrared detection element 11 of infrared sensor 100 according to the second example embodiment. Principal body 21 has reverse-side electrode layer 24C connected to back surface 222 of temperature sensing layer 22, but the structure is otherwise the same as in the first example embodiment. First and second electrode layers 24A and 24B and reverse-side electrode layer 24C supply current to temperature sensing layer 22 in the direction of film thickness (Z-direction) of temperature sensing layer 22. In the example shown in FIG. 6, infrared absorption layer 25 is provided on the side of incidence of infrared rays as viewed from temperature sensing layer 22. However, as a variation (not shown in the figures), infrared absorption layer 25 may be provided on the opposite side of temperature sensing layer 22 from the incident side, and reverse-side electrode layer 24C may be provided between temperature sensing layer 22 and infrared absorption layer 25. In this case, dielectric layer 23 may be provided between reverse-side electrode layer 24C and infrared absorption layer 25, and as a result, reverse-side electrode layer 24C may not be in contact with infrared absorption layer 25. Reverse-side electrode layer 24C may also be in contact with infrared absorption layer 25. If reverse-side electrode layer 24C is in contact with infrared absorption layer 25, some of the electric current may possibly flow through (leak to) infrared absorption layer 25. Even in such a case, however, this flow may have hardly any effect on the current flowing through temperature sensing layer 22 and thus have little effect on the detection accuracy of temperature change in temperature sensing layer 22. In other words, one electrode layer may be connected to one of incident surface 221 and back surface 222 (back surface 222 in this example embodiment), and two electrode layers may be connected to the other of incident surface 221 and back surface 222 (incident surface 221 in this example embodiment), with the result that one electrode layer may be provided between temperature detection layer 22 and infrared absorption layer 25. The one electrode layer and the two electrode layers supply current to temperature sensing layer 22 in the direction of thickness of temperature sensing layer 22 (Z-direction).

### Third Example Embodiment

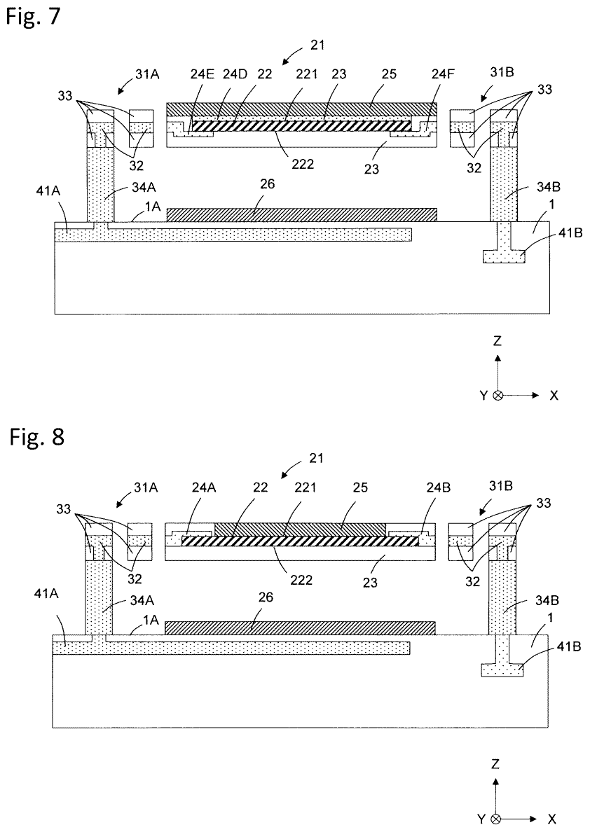

FIG. 7 is a partial schematic side view of infrared detection element 11 of infrared sensor 100 according to the third example embodiment. Principal body 21 has one incident-side electrode layer 24D connected to incident surface 221 of temperature sensing layer 22 and two reverse-side electrode layers 24E and 24F connected to back surface 222 of temperature sensing layer 22. Incident-side electrode layer 24D is provided over almost the entire surface of incident surface 221 of temperature sensing layer 22. Incident-side electrode layer 24D is in contact with infrared absorption layer 25. The two reverse-side electrode layers 24E and 24F correspond to first and second electrode layers 24A and 24B of the first example embodiment. Incident-side electrode layer 24D and the two reverse-side electrode layers 24E, 24F supply temperature sensing layer 22 with a current in the direction of film thickness (Z-direction) of temperature sensing layer 22. The current flows through incident-side electrode layer 24D, two reverse-side electrode layers 24E and 24F and temperature sensing layer 22. A portion of the current may flow through (leak to) infrared absorption layer 25, but even in this case, the current flowing through temperature sensing layer 22 may be little affected, and the detection accuracy of the temperature change in temperature sensing layer 22 may exhibit little change. The example embodiment shown in FIG. 7 allows a simplification of the manufacturing process of infrared sensor 100 because dielectric layer 23 between temperature sensing layer 22 and infrared absorption layer 25 in the first and second example embodiments can be omitted. In the example shown in FIG. 7, incident-side electrode layer 24D is in contact with infrared absorption layer 25. However, as a variation (not shown), dielectric layer 23 may be provided between incident-side electrode layer 24D and infrared absorption layer 25, with the result that incident-side electrode layer 24D may not be in contact with infrared absorption layer 25. In other words, one electrode layer may be connected to one of incident surface 221 and back surface 222 (incident surface 221 in this example embodiment) and two electrode layers may be connected to the other of incident surface 221 and back surface 222 (back surface 222 in this example embodiment) with the result that one electrode layer may be provided between temperature sensing layer 22 and infrared absorption layer 25. The one electrode layer and the two electrode layers supply current to temperature sensing layer 22 in the direction of thickness of temperature sensing layer 22 (Z-direction).

### Fourth Example Embodiment

FIG. 8 is a partial schematic side view of infrared detection element 11 of infrared sensor 100 according to the fourth example embodiment. In this example embodiment, dielectric layer 23 between temperature sensing layer 22 and infrared absorption layer 25 in the first example embodiment is omitted, but the structure is otherwise the same as in the first example embodiment. Temperature sensing layer 22 is in contact with infrared absorption layer 25. First and second electrode layers 24A and 24B supply current to temperature sensing layer 22 in the in-plane direction (X-Y plane) of temperature sensing layer 22. Part of the current flows through infrared absorption layer 25 and bypasses temperature sensing layer 22. However, because the conductivity of temperature sensing layer 22 is higher than that of infrared absorption layer 25, the current flowing through infrared absorption layer 25 (bypassing temperature sensing layer 22) is limited. As a result, the detection accuracy of temperature change (resistance change) of temperature sensing layer 22 in this example embodiment may again not be significantly affected.

In the illustrated example, infrared absorption layer 25 is separated from first and second electrode layers 24A and 24B, but may also be in contact with first and second electrode layers 24A and 24B. First and second electrode layers 24A and 24B are connected to incident surface 221 of temperature sensing layer 22, but alternatively, may be connected to back surface 222 of temperature sensing layer 22. Because dielectric layer 23 between temperature sensing layer 22 and infrared absorption layer 25 in the first example embodiment can be omitted, the manufacturing process of infrared sensor 100 in this example embodiment can be simplified.

### Fifth Example Embodiment

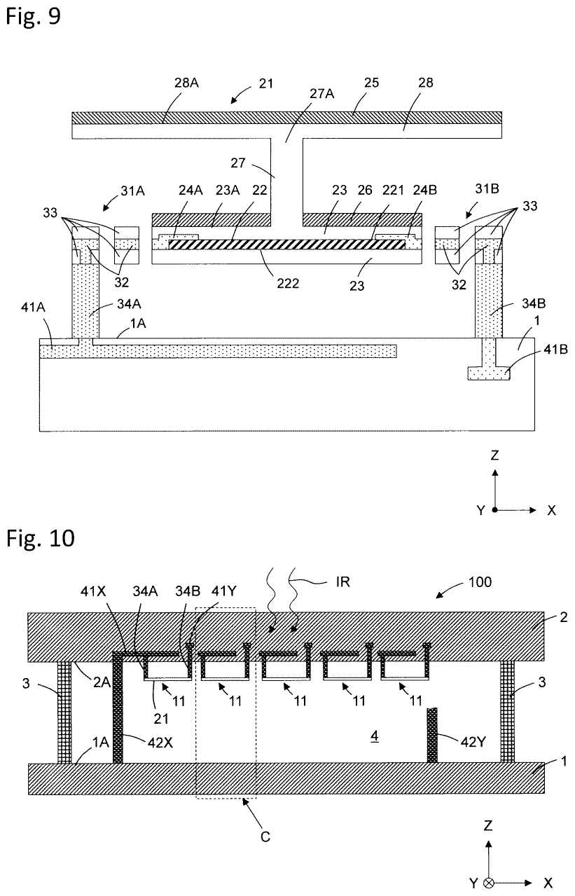

FIG. 9 is a partial schematic side view of infrared detection element 11 of infrared sensor 100 according to the fifth example embodiment. Principal body 21 has: arm 27 extending in the Z-direction toward second substrate 2 from surface 23A of dielectric layer 23 that faces second substrate 2; and plate part 28 connected to end 27A on the second-substrate-2 side of arm 27. Plate part 28 is more toward the side of infrared incidence compared to dielectric layer 23. Arm 27 and plate part 28 may be made of a dielectric material and may be formed of aluminum nitride, silicon nitride, aluminum oxide, or silicon oxide, or may be formed of the same material as dielectric layer 23.

Infrared absorption layer 25 is provided on surface 28A of plate part 28 that faces second substrate 2. Infrared absorption layer 25 can be provided over all of surface 28A of plate part 28 but may also be provided on only a portion of surface 28A. Incident infrared rays are absorbed by infrared absorption layer 25, and the heat generated in infrared absorption layer 25 propagates through plate part 28, arm 27, and dielectric layer 23 to temperature sensing layer 22. In other words, in this example embodiment, temperature sensing layer 22 and infrared absorption layer 25 are thermally connected through plate part 28, arm 27 and dielectric layer 23. Infrared reflecting layer 26 is provided on surface 23A that faces second substrate 2 of dielectric layer 23. Plate part 28 may be provided in the area that overlies first and second suspensions 31A and 31B as viewed from the Z-direction and thus ensure a wider flat area than dielectric layer 23. The flat area of the infrared absorber can therefore be larger than in the first example embodiment to further improve the infrared absorption performance. The infrared absorption performance can be further improved because plate part 28 itself also functions as an infrared absorber.

### Sixth Example Embodiment

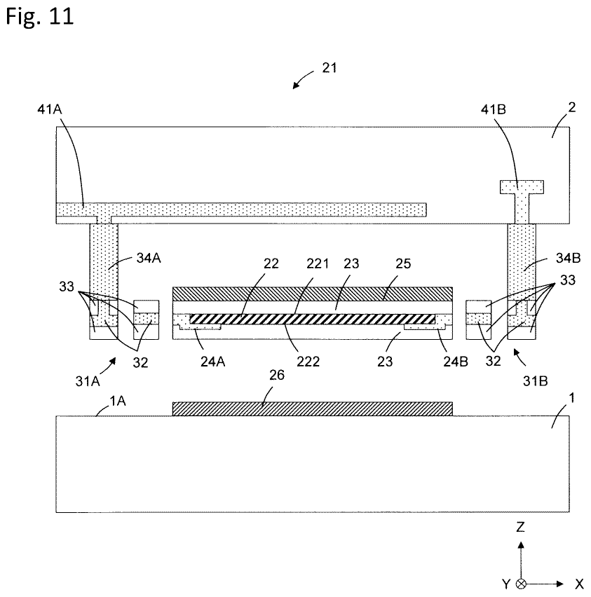

FIG. 10 is a schematic side view of infrared sensor 100 according to the sixth example embodiment, and FIG. 11 is an enlarged view of section C of FIG. 10. Infrared sensor 100 has first electrical connection members 42X and second electrical connection members 42Y. First and second electrical connection members 42X and 42Y are cylindrical conductors that extend in the Z-direction between first substrate 1 and second substrate 2 and that are electrically connected to ROIC. First wirings 41X and second wirings 41Y are provided on second substrate 2, and infrared detection elements 11 are supported by second substrate 2. The first wirings 41X are each connected to corresponding first electrical connection member 42X, and the second wirings 41Y are each connected to corresponding second electrical connection member 42Y. (In FIG. 10, only one of the second electrical connection members 42Y is shown and only a part of second electrical connection member 42Y in the Z-direction is shown.) The structure of principal body 21, first and second suspensions 31A and 31B, first and second conductive struts 34A and 34B, and first and second wirings 41X and 41Y are the same as in the first example embodiment.

In this example embodiment, principal body 21 is supported on second substrate 2 by first and second conductive struts 34A and 34B. This configuration may allow a longer heat transfer path from local heat sources such as ROIC on first substrate 1 than in the first example embodiment, and may therefore reduce the effect of heat from local heat sources upon temperature sensing layer 22. In this example embodiment, the first wirings 41X and the second wirings 41Y are provided on second substrate 2, and each temperature sensing layer 22 is electrically connected to corresponding first wiring 41X and second wiring 41Y via first and second conductive struts 34A and 34B. In one variation, for example, one or both of the first wirings 41X and the second wirings 41Y may be provided between infrared detection elements 11 and first substrate 1, and temperature detection layers 22 and these wirings may be electrically connected via different conductive struts. In this case, the struts that support principal body 21 on second substrate 2 may be nonconductive unless these struts are responsible for electrical connection of the first wirings 41X to temperature sensing layers 22 or the second wirings 41Y to temperature sensing layers 22. This example embodiment may be combined with the second through fifth example embodiments. That is, the structure of principal body 21 may be the same as principal body 21 of the second through fifth example embodiments.

The above-described example embodiments of the infrared sensor of the present disclosure are not limited to these example embodiments. In each of the above example embodiments, infrared absorption layer 25 is provided only on the infrared-incident side as viewed from temperature sensing layer 22, but the infrared absorption layer may be formed on only the side opposite the incident side of temperature sensing layer 22 or on both sides. The infrared absorption layer on the side opposite the incident side absorbs infrared rays transmitted through temperature sensing layer 22, and the heat generated in the infrared absorption layer propagates to temperature sensing layer 22, thus increasing the infrared absorption efficiency similarly to infrared absorption layers 25 formed on the incident side. When infrared absorption layers are formed on both the incident side and the opposite side, the infrared absorption layers on both sides may have the same composition or may have different compositions. For example, infrared absorption layer 25 on the incident side may include only iron oxide (II, III), while the infrared absorption layer on the side opposite the incident side may include both iron oxide (II, III) and iron oxide (III). This configuration can increase the infrared absorption efficiency in the wavelength range of at least 1 μm to 20 μm and may further increase the infrared absorption efficiency for wavelengths exceeding about 15 μm.

Although some example embodiments of the present disclosure have been shown and described in detail, it is to be understood that various changes and modifications are possible without departing from the intent or scope of the appended claims.

### REFERENCE NUMERALS

1 first substrate
2 second substrate
11 infrared detection element
21 principal body
22 temperature sensing layer
23 dielectric layer
24A-24F electrode layers
25 infrared absorption layer
34A, 34B first and second conductive struts
100 infrared sensor

1. An infrared detection element comprising:
a temperature sensing layer; and
an infrared absorption layer that is provided in addition to the temperature sensing layer for absorbing infrared rays and converting the infrared rays into heat, wherein
the temperature sensing layer is thermally connected to the infrared absorption layer, and
the infrared absorption layer includes an iron oxide.

2. The infrared detection element according to claim 1, wherein the iron oxide includes at least one of iron oxide (II, III) and iron oxide (III).

3. The infrared detection element according to claim 1, wherein at least a portion of the iron oxide has an inverse spinel structure.

4. The infrared detection element according to claim 1, wherein the absolute value of a temperature coefficient of resistance of the temperature sensing layer at 300 K is equal to or greater than 2.

5. The infrared detection element according to claim 1, wherein the absolute value of the temperature coefficient of resistance of the temperature sensing layer at 300 K is equal to or greater than 3.

6. The infrared detection element according to claim 1, wherein the temperature sensing layer includes at least one of vanadium oxide, amorphous silicon, polycrystalline silicon, spinel-type crystal structure oxide that includes manganese, titanium oxide, and yttrium-barium-copper oxide.

7. The infrared detection element according to claim 1 comprising a dielectric layer that is provided between the temperature sensing layer and the infrared absorption layer.

8. The infrared detection element according to claim 1 comprising:
one electrode layer connected to one of an incident surface into which enter infrared rays to be detected and a back surface opposite the incident surface; and
two electrode layers connected to the other of the incident surface and the back surface, wherein
said one electrode layer and said two electrode layers supply current to the temperature sensing layer in a direction of thickness of the temperature sensing layer, and
said one electrode layer is provided between the temperature sensing layer and the infrared absorption layer.

9. The infrared detection element according to claim 1 comprising two electrode layers electrically connected to the temperature sensing layer, wherein
said two electrode layers supply current to the temperature sensing layer in an in-plane direction of the temperature sensing layer, and
the temperature sensing layer is in contact with the infrared absorption layer, and conductivity of the temperature sensing layer is higher than conductivity of the infrared absorption layer.

10. The infrared detection element according to claim 1 comprising:
a principal body comprising the temperature sensing layer and the infrared absorption layer;
a substrate on a side of the principal body into which enter infrared rays to be detected; and
a strut by which the principal body is supported by the substrate.

11. An infrared sensor comprising the infrared detection element according to claim 1.

12. An infrared sensor comprising a plurality of the infrared detection elements according to claim 1, wherein
the infrared detection elements are arranged in an array.
